(19) United States
(12) Patent Application Publication
(10) Pub. No.: US 2026/0239049 A1
(43) Pub. Date: Aug. 13, 2026

(54) DISPLAY SYSTEM, DISPLAY DEVICE, AND DISPLAY METHOD

(71) Applicant: NEC Corporation, Tokyo (JP)

(72) Inventors: Yoshiaki NISHIKAWA, Tokyo (JP); Shohei MARUYAMA, Tokyo (JP); Takeo ONISHI, Tokyo (JP); Eiji TAKAHASHI, Tokyo (JP)

(73) Assignee: NEC Corporation, Tokyo (JP)

(21) Appl. No.: 19/156,001

(22) PCT Filed: Feb. 20, 2023
(86) PCT No.: PCT/JP2023/006042

§ 371 Date: Aug. 13, 2025

(51) Int. Cl. H04W 24/08; H04L 41/22

(52) U.S. Cl. CPC H04W 24/08; H04L 41/22

(57) ABSTRACT

A display system (10) comprises a generation unit (11) which generates a wireless communication quality map indicating a wireless communication quality distribution in a target space on the basis of wireless communication quality information relating to wireless communication quality in the target space, an estimation unit (12) which estimates a deterioration factor of the communication quality in the target space on the basis of the wireless communication quality information, and a display unit (13) which generates display information for displaying the deterioration factor of the communication quality estimated by the estimation unit (12) such that the deterioration factor is superimposed on the wireless communication quality map generated by the generation unit (11).

### TECHNICAL FIELD

The present disclosure relates to a display system, a display device, and a display method.

### BACKGROUND ART

In a system that performs wireless communication, the radio environment changes due to various factors and communication quality fluctuates. Therefore, a technology for managing the communication quality is used. For example, PTL 1 is known as a related technology. PTL 1 describes that a low quality cell is detected using call logs of a base station, and the detected low quality cell is displayed on a map.

### CITATION LIST

### Patent Literature

PTL 1: Japanese Unexamined Patent Application Publication No. 2017-208717

### SUMMARY OF INVENTION

### Technical Problem

However, in the related technology such as PTL 1, only the call logs of the base station are analyzed and only the low quality cell is displayed on the map. Therefore, it is difficult to effectively obtain information for supporting the management of communication quality.

In view of such a problem, an object of the present disclosure is to provide a display system, a display device, and a display method capable of effectively obtaining information for supporting the management of communication quality.

### Solution to Problem

According to the present disclosure, there is provided a display system including: a generation means for generating a wireless communication quality map indicating a wireless communication quality distribution in a target space based on wireless communication quality information regarding wireless communication quality in the target space; an estimation means for estimating a deterioration factor of communication quality in the target space based on the wireless communication quality information; and a display means for generating display information for superimposing and displaying the estimated deterioration factor of the communication quality on the generated wireless communication quality map.

According to the present disclosure, there is provided a display device including: a generation means for generating a wireless communication quality map indicating a wireless communication quality distribution in a target space based on wireless communication quality information regarding wireless communication quality in the target space; an estimation means for estimating a deterioration factor of communication quality in the target space based on the wireless communication quality information; and a display means for generating display information for superimposing and displaying the estimated deterioration factor of the communication quality on the generated wireless communication quality map.

According to the present disclosure, there is provided a display method including: generating a wireless communication quality map indicating a wireless communication quality distribution in a target space based on wireless communication quality information regarding wireless communication quality in the target space; estimating a deterioration factor of communication quality in the target space based on the wireless communication quality information; and generating display information for superimposing and displaying the estimated deterioration factor of the communication quality on the generated wireless communication quality map.

### Advantageous Effects of Invention

According to the present disclosure, it is possible to provide a display system, a display device, and a display method capable of effectively obtaining information for supporting the management of communication quality.

### BRIEF DESCRIPTION OF DRAWINGS

FIG. 1 is a diagram illustrating a display example of a related display method.

FIG. 2 is a diagram illustrating a display example of a display method according to an example embodiment.

FIG. 3 is a configuration diagram illustrating an outline of a display system according to the example embodiment.

FIG. 4 is a configuration diagram illustrating an outline of a display device according to the example embodiment.

FIG. 5 is a flowchart illustrating an outline of a display method according to the example embodiment.

FIG. 6 is a configuration diagram illustrating a configuration example of an operational management system according to a first example embodiment.

FIG. 7 is a configuration diagram illustrating a configuration example of a wireless information transmission function according to the first example embodiment.

FIG. 8 is a configuration diagram illustrating a configuration example of an operational management server according to the first example embodiment.

FIG. 9 is a flowchart illustrating an operational example of an operational management server according to the first example embodiment.

FIG. 10 is a flowchart illustrating an operational example of received power map generation processing according to the first example embodiment.

FIG. 11 is a diagram illustrating received power map generation processing according to the first example embodiment.

FIG. 12 is a diagram illustrating received power map generation processing according to the first example embodiment.

FIG. 13 is a diagram illustrating received power map generation processing according to the first example embodiment.

FIG. 14 is a diagram illustrating received power map generation processing according to the first example embodiment.

FIG. 15 is a diagram illustrating an example of an operational management screen according to the first example embodiment.

FIG. 16 is a diagram illustrating another example of an operational management screen according to the first example embodiment.

FIG. 17 is a diagram illustrating still another example of an operational management screen according to the first example embodiment.

FIG. 18 is a diagram illustrating still another example of an operational management screen according to the first example embodiment.

FIG. 19 is a diagram illustrating still another example of an operational management screen according to the first example embodiment.

FIG. 20 is a configuration diagram illustrating a configuration example of an operational management server according to a second example embodiment.

FIG. 21 is a flowchart illustrating an operational example of an operational management server according to the second example embodiment.

FIG. 22 is a diagram illustrating an example of an operational management screen according to the second example embodiment.

FIG. 23 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

### (Study for Achieving Example Embodiments)

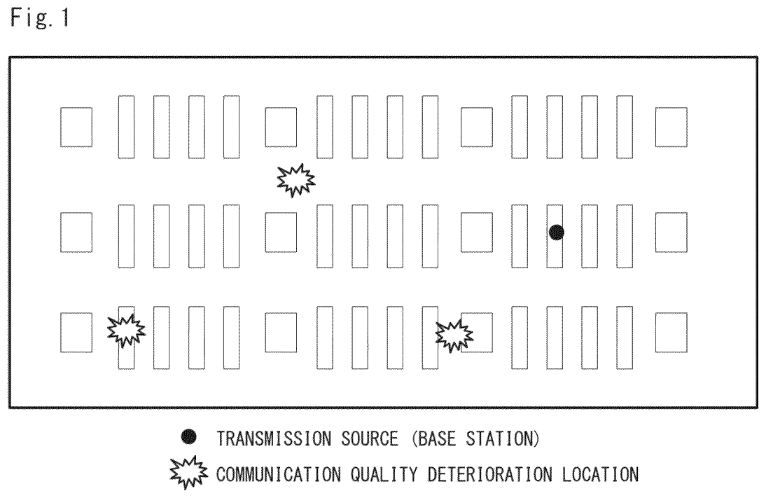

The inventor has studied a display method for an operator (administrator) to manage communication quality in a wireless communication system. As a related technology, for example, as illustrated in FIG. 1, a method for displaying a floor map of a floor where a wireless communication system provides a service and displaying locations with deteriorated communication quality on the floor map is considered. In the example of FIG. 1, an icon indicating deterioration of the communication quality is displayed at a point where the communication quality does not meet requirements, which is, for example, a delay. With this display, the operator can identify a location where the communication quality deteriorates, and considers countermeasures as necessary. However, even when the location where the communication quality deteriorates can be identified, it is difficult to specifically consider the countermeasures only based on the information of the deterioration location.

For example, in a case where an automated guided vehicle (AGV) that performs wireless communication moves on a floor of a warehouse or the like, even when the AGV stops due to deterioration of the communication quality, it is not possible to determine what has caused the stop from the display screen. Therefore, in the display method as illustrated in FIG. 1, although the location where the communication quality deteriorates can be identified, it is not possible to obtain information for supporting the management of communication quality, such as information necessary for considering the countermeasures.

Since the deterioration of communication quality occurring in a predetermined area such as a floor may be caused not by one factor but by a plurality of factors, there is a possibility that appropriate countermeasures cannot be considered and implemented even when it is simply found that the communication quality deteriorates. Since there is a case where the communication quality deteriorates due to different factors at adjacent points, there is a possibility that the countermeasures for a terminal at a predetermined point are not appropriate as countermeasures for all terminals including terminals at other points. In a case where the deterioration of the communication quality is caused by a plurality of factors, there is a possibility that the effective response varies depending on the extent to which the addressed factor influences the deterioration. However, a method for effectively presenting to the operator has not been considered in the related display method. Since items to be evaluated may be different depending on each site managed by the operator, it is desirable to be able to display necessary information corresponding to the items.

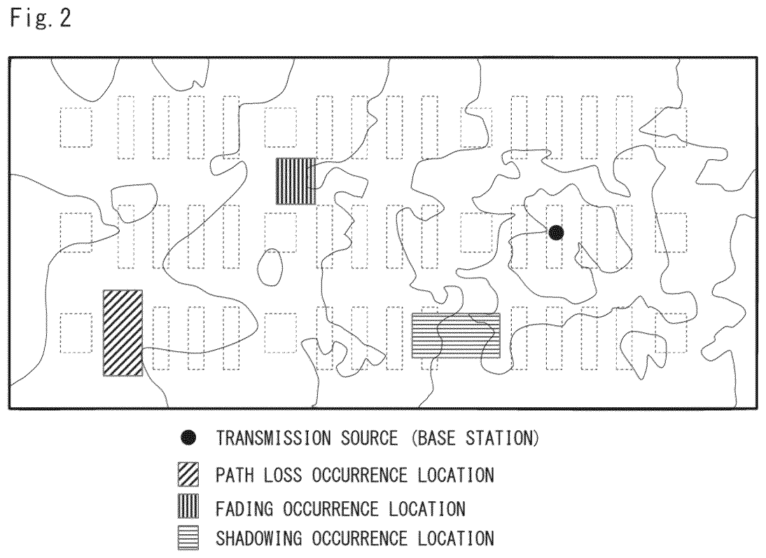

In the example embodiment, for example, as illustrated in FIG. 2, by displaying the deterioration factor of the communication quality at a point on the received power map indicating the received power distribution, where the communication quality does not meet the requirements, it is possible to effectively obtain information for supporting the management of communication quality.

### (Outline of Example Embodiment)

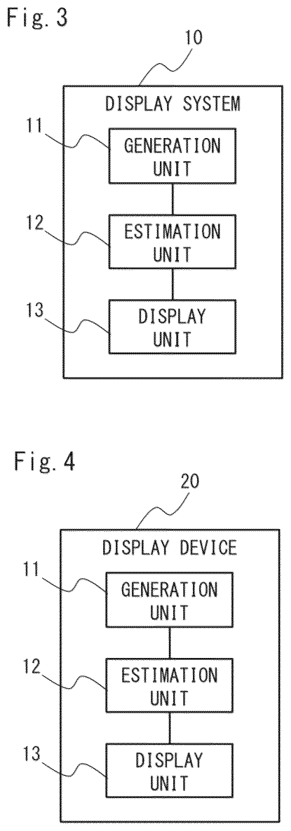

FIG. 3 illustrates a schematic configuration of a display system 10 according to the example embodiment. The display system 10 is, for example, a system that manages wireless communication quality in a wireless communication system in which an application terminal such as an AGV performs wireless communication.

As illustrated in FIG. 3, the display system 10 includes a generation unit 11, an estimation unit 12, and a display unit 13. The generation unit 11 generates a wireless communication quality map indicating a wireless communication quality distribution in a target space based on wireless communication quality information regarding wireless communication quality in the target space. The target space is a predetermined area, and is, for example, a floor on which the application terminal moves during operation. The wireless communication quality includes wireless quality related to radio waves or communication quality related to communication between communication devices. For example, the wireless quality is an indicator representing the received power or signal strength of radio waves, and includes Reference Signal Received Power (RSRP), Reference Signal Received Quality (RSRQ), Received Signal Strength Indicator (RSSI), and Signal to Interference plus Noise power Ratio (SINR). For example, the communication quality is an indicator representing traffic quality, and includes throughput and a delay time. It can be said that the wireless quality and the communication quality have a certain relationship. That is, there is a relationship in which the communication quality also deteriorates due to deterioration of the wireless quality, for example, a relationship in which the throughput also deteriorates due to deterioration of the RSSI. The generation unit 11 may generate a wireless quality map indicating a wireless quality distribution based on the wireless quality information such as received power, or may generate a communication quality map indicating a communication quality distribution based on the communication quality information such as throughput. The generation unit 11 may generate the wireless communication quality map based on the wireless communication quality information measured at a plurality of points in the target space.

The estimation unit 12 estimates a deterioration factor of the communication quality in the target space based on the wireless communication quality information. The estimation unit 12 may estimate the deterioration factor of the communication quality based on, for example, the wireless quality information such as received power included in the wireless communication quality information. The deterioration factor of the communication quality is a factor related to a radio propagation environment that deteriorates the communication quality such as the throughput, and for example, path loss, fading, shadowing, and the like are factors that cause fluctuations in the received power in the radio propagation environment. The estimation unit 12 may estimate the deterioration degree of the communication quality for each deterioration factor in the target space based on the wireless communication quality information. The deterioration degree is a degree of involvement of each deterioration factor in deterioration of the communication quality, and is an impact degree indicating how much each deterioration factor affects the deterioration of the communication quality. For example, the deterioration degree is an amount of throughput decrease caused by each deterioration factor such as path loss, fading, and shadowing.

The display unit 13 generates display information for superimposing and displaying the deterioration factor of the communication quality, which is estimated by the estimation unit 12, on the wireless communication quality map generated by the generation unit 11. The display unit 13 may display the wireless quality map indicating a wireless quality distribution such as received power or the communication quality map indicating a communication quality distribution such as throughput, and generate the display information for superimposing and displaying the deterioration factor of the communication quality on the wireless quality map or the communication quality map. For example, as illustrated in FIG. 2, the display unit 13 displays the received power map, and generates display information for identifiably displaying the estimated deterioration factor of the communication quality at the communication quality deterioration location on the reception power map. As in the example of FIG. 2, the display information may be displayed with different hatching patterns or colors for each deterioration factor such as path loss, fading, and shadowing, or may be displayed with different icons. In a case where the deterioration degree of the communication quality for each deterioration factor in the target space is estimated, the display unit 13 may generate display information for displaying the estimated deterioration degree in association with the wireless communication quality map. As an example of displaying the deterioration degree in association with the wireless communication quality map, the estimated deterioration degree may be superimposed and displayed at each position on the wireless communication quality map, or the estimated deterioration degree may be displayed on a screen (for example, a dashboard screen) different from the wireless communication quality map screen.

The display system 10 may be configured by one device or a plurality of devices. FIG. 4 illustrates a configuration example of a display device 20 according to the example embodiment. As illustrated in FIG. 4, the display device 20 may include the generation unit 11, the estimation unit 12, and the display unit 13, which are illustrated in FIG. 4. For example, all of the generation unit 11, the estimation unit 12, and the display unit 13 may be disposed in a management server or the like, or may be distributed and disposed in a plurality of devices. For example, the display unit 13 may display the generated display information, or may output the generated display information to an external device such as a display and display the display information through the external device.

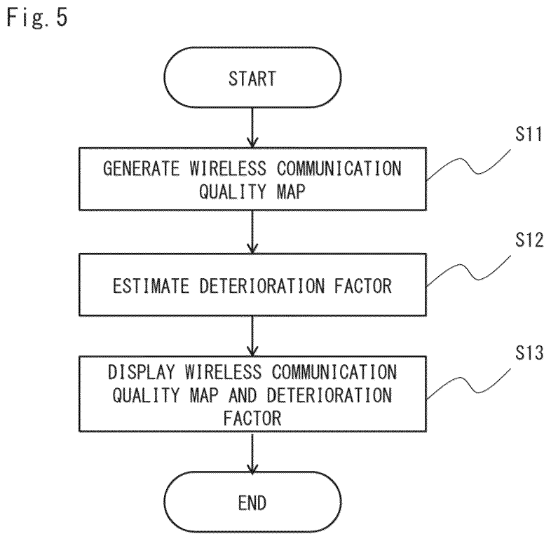

FIG. 5 illustrates a display method according to the example embodiment. For example, the display method according to the example embodiment is performed by the display system 10 or the display device 20 of FIGS. 3 and 4.

As illustrated in FIG. 5, the generation unit 11 generates a wireless communication quality map indicating a wireless communication quality distribution in a target space based on wireless communication quality information regarding wireless communication quality in the target space (S11). For example, the generation unit 11 generates a wireless quality map indicating a wireless quality distribution such as received power or a communication quality map indicating a communication quality distribution such as throughput.

Next, the estimation unit 12 estimates a deterioration factor of wireless communication quality in the target space based on the wireless communication quality information (S12). For example, the estimation unit 12 estimates the deterioration factor such as path loss, fading, and shadowing based on the wireless communication quality information.

Next, the display unit 13 generates display information for superimposing and displaying the estimated deterioration factor on the generated wireless communication quality map (S13). For example, the display unit 13 generates the display information for superimposing and displaying the deterioration factor such as the estimated path loss, fading, and shadowing on the wireless quality map or the communication quality map. The display unit 13 displays the generated display information and outputs the display information to an external device.

As described above, in the example embodiment, the wireless communication quality map such as the wireless quality map and the communication quality map is displayed, and the deterioration factor of the communication quality can be superimposed and displayed on the wireless communication quality map. Thus, it is possible to identify the deterioration factor of the communication quality at a glance along with the wireless communication quality at each point on the map. Therefore, it is possible to effectively obtain information for supporting the management of the communication quality from the displayed map.

### First Example Embodiment

Next, a first example embodiment will be described. In the present example embodiment, an example of superimposing and displaying the deterioration factor of the communication quality on a received power map will be described.

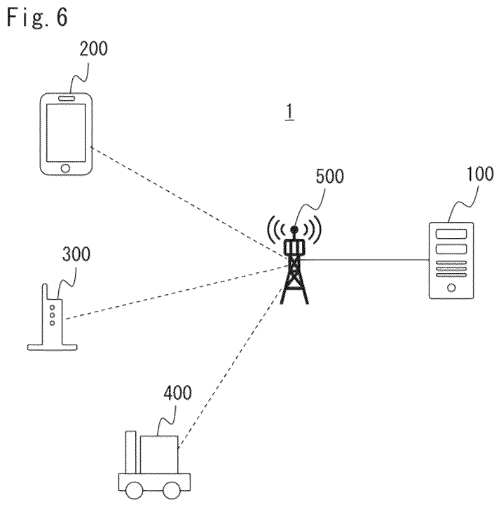

FIG. 6 illustrates a configuration example of an operational management system 1 according to the present example embodiment. The operational management system 1 is a system that manages an operational state of an application terminal such as an AGV and manages wireless quality and communication quality of a wireless communication environment (also referred to as a target wireless communication environment) in which the application terminal performs wireless communication. The target wireless communication environment is an environment of the wireless communication enabled by a radio waves transmitted from a predetermined transmission source. For example, the transmission source is a device that forms a communication area enabling wireless communication, and may be a base station for mobile communication, or may be an access point for a wireless local area network (LAN). In a case where the terminal transmits radio waves, the terminal may be the transmission source.

As illustrated in FIG. 6, the operational management system 1 includes an operational management server 100, an initial measurement terminal 200, an operational monitoring terminal 300, an application terminal 400, and a base station 500. The number of each of the initial measurement terminal 200, the operational monitoring terminal 300, and the application terminal 400 is not limited to one, and may be plural. One terminal may include functions of a plurality of terminals. Any of the initial measurement terminal 200, the operational monitoring terminal 300, and the application terminal 400 may be simply referred to as a terminal.

The initial measurement terminal 200, the operational monitoring terminal 300, and the application terminal 400 are wirelessly communicably connected to the base station 500. Each of the terminals and the base station 500 may be connected to be wirelessly communicable in both directions, or may be connected to be wirelessly communicable in at least one of uplink or downlink directions. For example, each of the terminals and the base station 500 are connected to be wirelessly communicable through a wireless network such as 4G, local 5G/5G, long term evolution (LTE), or wireless LAN. The base station 500 and the operational management server 100 may be connected to be able to perform wired communication or may be connected to be able to perform wireless communication. For example, the base station 500 and the operational management server 100 may be communicably connected via various networks such as a core network, the Internet, a wide area network (WAN), and a LAN, or a combination thereof.

The initial measurement terminal 200 is an example of a terminal that measures the wireless quality in the target wireless communication environment, and measures the wireless quality in the target wireless communication environment before the operation of the application terminal 400. For example, an initial received power map (first received power map) is generated by the operational management server 100 based on the wireless quality measured before the operation. A timing before the operation of the application terminal 400 is, for example, early morning before the warehouse starts its operation, in the case of the AGV. However, the timing for measuring the wireless quality in the target wireless communication environment is not limited to the timing before operation, and may be a time period during which the number of active devices is low, such as lunch break or nighttime idle hour or any timing when it is desired to reset the wireless communication quality map. The initial measurement terminal 200 is a movable mobile terminal, and is, for example, a mobile phone, a smartphone, a tablet terminal, an Internet of Things (IoT) terminal, or the like. The initial measurement terminal 200 measures the received power of the radio waves in the target wireless communication environment at each movement point, and transmits the measured received power and the positional information to the operational management server 100 via the base station 500. Not only the movable terminal but also a plurality of non-movable terminals may be used as the initial measurement terminals 200. In this case, a plurality of the initial measurement terminals 200 measure the received power of the radio waves at each installation point, and transmit the measured reception power and the positional information. For example, the initial measurement terminal 200 transmits wireless information including the measured received power and the positional information using a wireless information transmission function to be described later. The initial measurement terminal 200 may transmit the received power and the positional information, or may transmit only the received power. For example, the initial measurement terminal 200 may perform measurement at a preset position and transmit the measured received power.

The operational monitoring terminal 300 is an example of a terminal that measures the wireless quality in the target wireless communication environment, and measures the wireless quality in the target wireless communication environment during the operation of the application terminal 400. For example, a received power map for display is generated by the operational management server 100 based on the wireless quality measured during the operation. The operational monitoring terminal 300 is a terminal that measures the wireless quality at a position of a predetermined monitoring point, and may be a fixed terminal whose position is fixed at a predetermined monitoring point or a mobile terminal that can move to a predetermined monitoring point. The position of the monitoring point is not limited to a predetermined position, and may be, for example, a position (measurement point) where the terminal measures the wireless quality and reports the positional information. The operational monitoring terminal 300 is, for example, a fixed sensor, an IoT terminal, a base station, an access point, or the like. The operational monitoring terminal 300 may be the same device as the initial measurement terminal 200, and for example, the initial measurement terminal 200 may be used as the operational monitoring terminal 300, and the initial measurement terminal 200 may measure the wireless quality at a predetermined monitoring point. The operational monitoring terminal 300 measures the received power of the radio waves in the target wireless communication environment at a predetermined monitoring point, and transmits the measured received power to the operational management server 100 via the base station 500. For example, the operational monitoring terminal 300 transmits wireless information including the measured received power using a wireless information transmission function to be described later. The operational monitoring terminal 300 may transmit the wireless information including the measured received power and the positional information.

The application terminal 400 is an operation terminal that executes a function necessary for a predetermined application. The application terminal 400 is also an example of a terminal that measures the wireless quality in the target wireless communication environment, and executes the function of a predetermined application and measures the wireless quality in the target wireless communication environment during operation. For example, the operational management server 100 manages the operational state of the terminal based on the wireless quality measured during the operation. The application terminal 400 is a movable mobile terminal, and is, for example, an AGV, an autonomous mobile robot (AMR), an autonomous traveling robot, an autonomous vehicle, a drone, or the like. The application terminal 400 may be the same device as the initial measurement terminal 200. The application terminal 400 may or may not be moved as long as the measured wireless quality can be reported. The application terminal 400 measures the received power of the radio waves in the target wireless communication environment at each movement point, and transmits the measured received power and the positional information to the operational management server 100 via the base station 500. For example, the application terminal 400 transmits wireless information including the measured received power and the positional information using a wireless information transmission function to be described later.

The base station 500 is a base station device in a wireless network among the initial measurement terminal 200, the operational monitoring terminal 300, and the application terminal 400, and is also a relay device that relays communication among the initial measurement terminal 200, the operational monitoring terminal 300, the application terminal 400, and the operational management server 100. For example, the base station 500 is a local 5G base station, a 5G next Generation Node B (gNB), an LTE evolved Node B (eNB), an access point of a wireless LAN, a master device of Bluetooth (registered trademark), or the like, but may be another relay device. In order to transfer the received power measured by each terminal in the target wireless communication environment to the operational management server 100, the base station 500 is, for example, a device different from the transmission source in the target wireless communication environment, but may be the same device as the transmission source in the target wireless communication environment. In addition to the base station 500, there may be another network for transferring the received power measured by each terminal in the target wireless communication environment to the operational management server 100.

The operational management server 100 is a server that manages the operational state of the application terminal 400 and manages the wireless quality and the communication quality in the target wireless communication environment. The operational management server 100 generates a received power map indicating a received power distribution in the target wireless communication environment based on the wireless information received from any one of the initial measurement terminal 200, the operational monitoring terminal 300, and the application terminal 400, and displays the generated received power map. Not only the received power map but also a wireless quality map indicating another wireless quality distribution may be generated and displayed. The operational management server 100 estimates the deterioration factor of the communication quality in the target wireless communication environment and the impact degree on the communication quality for each deterioration factor based on the received power included in the wireless information received from any one of the initial measurement terminal 200, the operational monitoring terminal 300, and the application terminal 400 or based on the received power included in the generated received power map, and displays the estimated deterioration factor and the impact degree on the received power map.

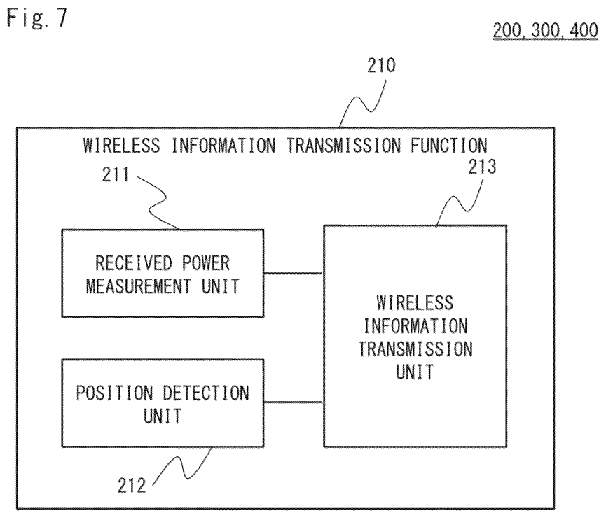

FIG. 7 illustrates a configuration example of a wireless information transmission function 210 according to the present example embodiment. The wireless information transmission function 210 is included in the initial measurement terminal 200, the operational monitoring terminal 300, and the application terminal 400. As illustrated in FIG. 7, the wireless information transmission function 210 includes a received power measurement unit 211, a position detection unit 212, and a wireless information transmission unit 213.

The received power measurement unit 211 measures the received power of the radio waves in the target wireless communication environment. The received power measurement unit 211 receives the radio waves transmitted from the transmission source in the target wireless communication environment, and measures the received power (signal strength) of the received radio wave. The received power is, for example, RSRP, RSRQ, RSSI, SINR, or the like, and may be an indicator representing any other wireless quality. The received power measurement unit 211 outputs received power information indicating the measured received power.

The position detection unit 212 detects the current position of the terminal including the wireless information transmission function 210. For example, the position detection unit 212 may detect the position using a global navigation satellite system (GNSS) such as a global positioning system (GPS), or may detect the position by analyzing an image from a camera installed at a place where a predetermined area is looked down. The position detection unit 212 may detect the position of the terminal including the wireless information transmission function 210 based on information regarding a beacon, short-range wireless communication, and reflected laser light such as Lidar. The position detection unit 212 may detect the position using a delay time in wireless communication. The wireless signal used for these may be light such as visible light or infrared light, or may be a radio wave whose frequency is not limited. The position may be detected by other detection methods. The position detection unit 212 outputs positional information indicating the detected position. In the case of the operational monitoring terminal 300, since measurement is performed at a position of a predetermined monitoring point, the position detection unit 212 may not be provided. The same applies to a case where the initial measurement terminal 200 performs measurement at a predetermined position.

The wireless information transmission unit 213 transmits wireless information including the received power information measured by the received power measurement unit 211 and the positional information detected by the position detection unit 212 to the operational management server 100 via the base station 500. In the case of the operational monitoring terminal 300, the wireless information transmission unit 213 may transmit only the received power information as the wireless information. The same applies to a case where the initial measurement terminal 200 performs measurement at a predetermined position. The wireless information transmission unit 213 is a communication interface capable of communicating with the base station 500, and is, for example, a wireless interface such as 4G, local 5G/5G, LTE, or a wireless LAN, but may be a wireless interface of any other communication system.

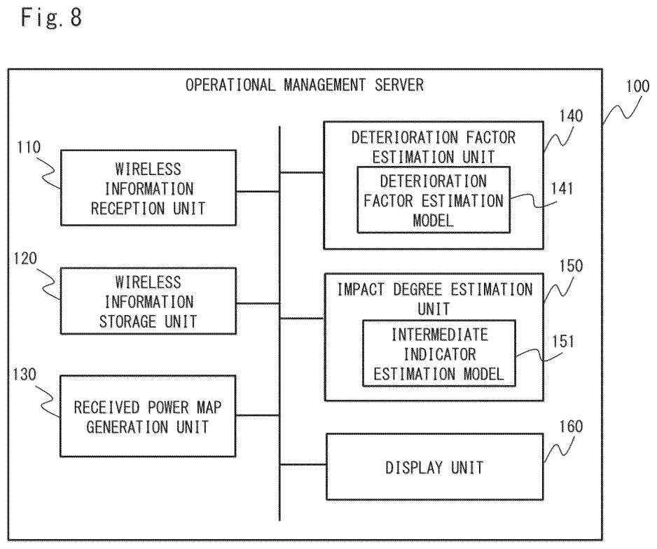

FIG. 8 illustrates a configuration example of the operational management server 100 according to the present example embodiment. The configuration is an example, and another configuration may be used as long as the operation according to the present example embodiment to be described later can be performed. For example, some components of the operational management server 100 may be disposed in another device, or the components of the operational management server 100 may be disposed in a plurality of devices in a distributed manner. As illustrated in FIG. 8, the operational management server 100 includes a wireless information reception unit 110, a wireless information storage unit 120, a received power map generation unit 130, a deterioration factor estimation unit 140, an impact degree estimation unit 150, and a display unit 160.

The wireless information reception unit 110 receives the wireless information transmitted from the initial measurement terminal 200, the operational monitoring terminal 300, and the application terminal 400 via the base station 500. The wireless information reception unit 110 acquires wireless information including the received power information and positional information transmitted from each terminal. The wireless information reception unit 110 may acquire the wireless information including only the received power information from the operational monitoring terminal 300. The wireless information reception unit 110 is a communication interface capable of communicating with the Internet or a core network, and is, for example, a wired interface for IP communication, but may be a wired or wireless interface of any other communication system.

The wireless information storage unit 120 is a database that stores the wireless information received by the wireless information reception unit 110. The wireless information storage unit 120 accumulates the wireless information acquired from the initial measurement terminal 200, the operational monitoring terminal 300, and the application terminal 400 as time-series data. The wireless information reception unit 110 may output the received wireless information to the received power map generation unit 130 or the like.

The received power map generation unit 130 generates a received power map based on the wireless information received by the wireless information reception unit 110 from each terminal and stored in the wireless information storage unit 120. The received power map generation unit 130 generates the received power map indicating a received power distribution in a predetermined area in the target wireless communication environment based on the received power information and positional information included in the wireless information. For example, the predetermined area is a floor on which the application terminal 400 moves during operation.

The received power map generation unit 130 may generate the received power map based on the wireless information acquired from any one of the initial measurement terminal 200, the operational monitoring terminal 300, and the application terminal 400, or may generate the received power map based on the wireless information acquired from each terminal. For example, before operation, an initial received power map may be generated based on the wireless information at each point measured while the initial measurement terminal 200 moves, and thereafter, during the operation, the initial received power map may be corrected based on the wireless information at each point measured at the monitoring point by the operational monitoring terminal 300, and the corrected received power map may be output as the received power map for display. During the operation, the received power map to be displayed may be updated based on the wireless information measured at the monitoring point by the operational monitoring terminal 300 or the wireless information measured by the application terminal 400.

The deterioration factor estimation unit 140 estimates the deterioration factor of the communication quality at each point on the received power map based on the received power information included in the wireless information received by the wireless information reception unit 110 from each terminal and stored in the wireless information storage unit 120 or the received power information included in the received power map generated by the received power map generation unit 130.

The communication quality indicates, for example, throughput, a delay time, jitter, the number of hybrid automatic repeat request (HARQ) retransmissions, the number of exceeded HARQ retransmissions, the number of radio link control (RLC) retransmissions, a block error rate (BLER), a packet loss rate, and a bit error rate (BER), or the like. The state where the communication quality is deteriorated is, for example, a state where the communication quality is lower than the allowable lower limit. The deterioration factors of the communication quality to be estimated are, for example, path loss, fading, shadowing, and the like. The deterioration of the communication quality caused by path loss is deterioration of the communication quality caused by the fact that the distance between the transmission source and the terminal is longer than an appropriate distance at which appropriate wireless communication can be performed. The deterioration of the communication quality caused by fading is deterioration of the communication quality caused by occurrence of at least one of interference fading (also known as multipath fading), polarization fading, skip fading, absorption fading, selective fading, or K-factor fading. The deterioration of the communication quality caused by shadowing is deterioration of the communication quality caused by that fact that a physical obstacle that blocks radio waves (that is, obstructs radio wave propagation) is present between the transmission source and the terminal.

The deterioration factor of the communication quality may be interference, congestion, handover, or the like. The deterioration of the communication quality caused by interference is deterioration of the communication quality caused by mutual interference among radio waves transmitted from a plurality of transmission sources. The deterioration of the communication quality caused by congestion is deterioration of the communication quality caused by insufficient radio resources allocated to the terminal. The deterioration of the communication quality caused by the handover is deterioration of the communication quality caused by the terminal near the boundary between the cells of two adjacent base stations repeating handover between two base stations.

For example, the deterioration factor estimation unit 140 may estimate the deterioration factor of the communication quality from the received power information using a deterioration factor estimation model 141 that estimates the deterioration factor. The deterioration factor estimation model 141 is a machine learning model trained using deterioration factors of the communication quality corresponding to the time series of the received power information. The deterioration factor estimation model 141 may be stored in a storage unit inside the operational management server 100 or in an external storage device. The deterioration factor estimation model 141 may be a Convolutional Neural Network (CNN), a Recurrent Neural Network (RNN), a Long-Short Term Model (LSTM), or another neural network. The deterioration factor estimation model 141 is not limited to the neural network, and may be another machine learning model. The deterioration factor estimation unit 140 inputs the time series of the received power information to the deterioration factor estimation model 141 to estimate the deterioration factor of the communication quality.

The impact degree estimation unit 150 estimates the impact degree on the communication quality for each deterioration factor at each point on the received power map based on the received power information included in the wireless information received by the wireless information reception unit 110 from each terminal and stored in the wireless information storage unit 120 or the received power information included in the received power map generated by the received power map generation unit 130. The impact degree on the communication quality for each deterioration factor is the deterioration degree of the communication quality for each deterioration factor. The deterioration degree may be a deterioration rate of the communication quality or a deterioration amount of the communication quality.

The impact degree estimation unit 150 may estimate the deterioration degree of the communication quality for each deterioration factor by using a machine learning model trained using the deterioration degree (impact degree) on the communication quality for each deterioration factor corresponding to the time series of the received power information. For example, the impact degree estimation unit 150 may estimate the deterioration degree of the communication quality for each deterioration factor by using an intermediate indicator estimation model 151 that estimates an intermediate indicator for obtaining the deterioration degree. The intermediate indicator is a physical indicator that represents the tendency (intensity) of the deterioration factor, and is, for example, an initial distance (for example, the transmitter is a transmission source, and the receiver is a terminal) between the transmitter and the receiver, a movement speed of the receiver, shadowing attenuation, a K-factor, or like. The initial distance between the transmitter and the receiver, and the movement speed of the receiver are examples of physical indicators representing the tendency of the deterioration factor of the path loss. The shadowing attenuation is an example of a physical indicator representing a tendency of the shadowing deterioration factor. The K-factor is an example of a physical indicator representing a tendency of a fading deterioration factor. The K-factor is a ratio of the power of the direct wave to the power of the sum of N component waves. The intermediate indicator estimation model 151 is a machine learning model trained using intermediate indicators corresponding to the time series of the received power information. The intermediate indicator estimation model 151 may be stored in a storage unit inside the operational management server 100 or in an external storage device. The intermediate indicator estimation model 151 may be a CNN, an RNN, or an LSTM, or may be another neural network. The intermediate indicator estimation model 151 is not limited to the neural network, and may be another machine learning model. The impact degree estimation unit 150 inputs the received power information to the intermediate indicator estimation model 151 to estimate the intermediate indicator. The impact degree estimation unit 150 transforms the estimated intermediate indicator into the deterioration degree of the communication quality for each deterioration factor using a predetermined transformation function.

The display unit 160 generates display information for displaying a processing result or the like of each unit of the operational management server 100. The display unit 160 includes, for example, a display device such as a liquid crystal display or an organic EL display, and may display the generated display information. The display unit 160 may output the generated display information to a display device outside the operational management server 100 and display the generated display information on an external display device. For example, the display unit 160 displays the generated display information on the operational management screen through a graphical user interface (GUI). The display information includes information for displaying a received power map, a deterioration factor estimation result, an impact degree estimation result, and the like. Since the processing of displaying on the screen includes processing of generating display information to be displayed on the screen and processing of displaying the generated display information, there is a case where the processing of generating the display information and displaying the generated information is simply described as displaying. The display unit 160 displays the received power map generated by the received power map generation unit 130 on the operational management screen, and superimposes and displays the deterioration factor estimation result of the deterioration factor estimation unit 140 and the impact degree estimation result of the impact degree estimation unit 150 on the received power map. The display unit 160 may acquire information regarding a floor map indicating a predetermined floor from a storage unit inside the operational management server 100 or an external storage device, and display the received power map on the floor map.

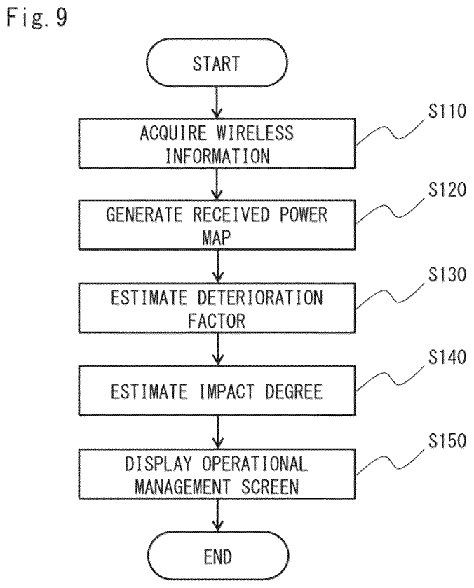

FIG. 9 illustrates an operational example of the operational management server 100 according to the present example embodiment. The flow of the processing in FIG. 9 is an example, and the order of the processing is not limited as long as the operational management screen can be displayed. For example, deterioration factor estimation processing (S130) and impact degree estimation processing (S140) may be executed in parallel, or one of them may be executed first. Only either the deterioration factor estimation processing (S130) or the impact degree estimation processing (S140) may be executed.

Operational management screen display processing (S150) may be sequentially executed for the received power map generation processing (S120), the deterioration factor estimation processing (S130), and the impact degree estimation processing (S140). For example, the received power map may be displayed on the operational management screen by executing the operational management screen display processing (S150) following the received power map generation processing (S120), and the deterioration factor estimation result and the impact degree estimation result may be displayed on the operational management screen by executing the operational management screen display processing (S150) following the deterioration factor estimation processing (S130) and the impact degree estimation processing (S140). Any or all of the received power map generation processing (S120), the deterioration factor estimation processing (S130), and the impact degree estimation processing (S140) may be executed and the operational management screen display processing (S150) may be executed, at a timing corresponding to an operator's operation, a timing based on a predetermined cycle, or the like.

As illustrated in FIG. 9, the operational management server 100 acquires wireless information (S110). The wireless information reception unit 110 receives wireless information from each terminal, and stores the received wireless information in the wireless information storage unit 120. For example, the wireless information reception unit 110 acquires wireless information from the initial measurement terminal 200 before operation as information for generating a received power map, and acquires wireless information from the operational monitoring terminal 300 during the operation. The wireless information reception unit 110 acquires wireless information from the application terminal 400 during the operation as information for managing the application terminal 400.

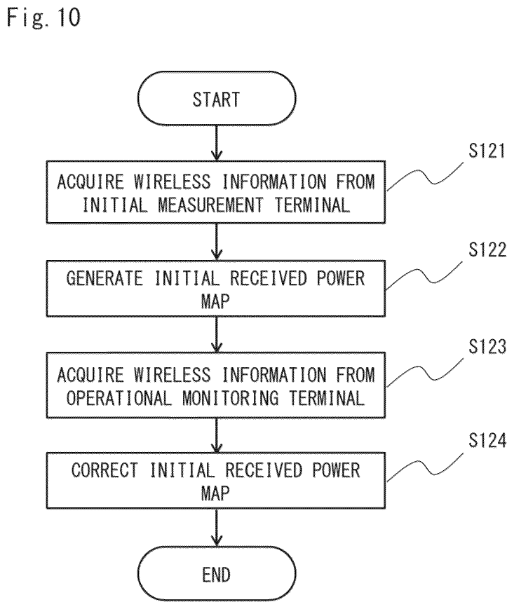

Subsequently, the operational management server 100 generates a received power map from the acquired wireless information (S120). A specific example of the received power map generation processing according to the present example embodiment will be described with reference to FIG. 10. FIG. 10 includes the wireless information acquisition processing (S110) and the received power map generation processing (S120), which are illustrated in FIG. 9.

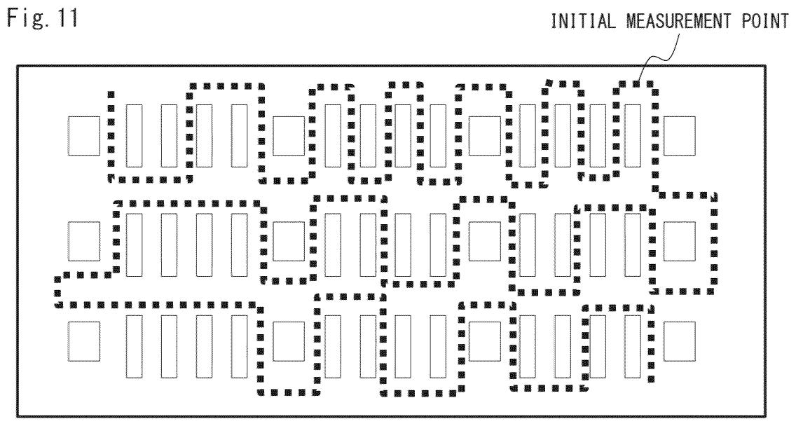

As illustrated in FIG. 10, the received power map generation unit 130 acquires wireless information from the initial measurement terminal 200 before operation (S121). For example, before the operation, a measurer moves on the floor with the initial measurement terminal 200, and the initial measurement terminal 200 measures the received power at a plurality of points at a movement destination, and transmits the measured received power information and the positional information to the operational management server 100. Not only the measurer but also a robot such as an AGV, which is equipped with the initial measurement terminal 200, may move on the floor and measure the received power at the point at the movement destination. The initial measurement terminals 200 may be installed at a plurality of points, and the received power may be measured at a plurality of fixed positions where the initial measurement terminals 200 are installed. The wireless information reception unit 110 of the operational management server 100 receives the wireless information including the received power information and the positional information at a plurality of points from the initial measurement terminal 200, and stores the received wireless information in the wireless information storage unit 120. For example, as illustrated in FIG. 11, the initial measurement terminal 200 moves on the floor, measures the received power at a large number of initial measurement points on the movement route, and stores the wireless information including the positional information and the received power information at the large number of initial measurement points in the wireless information storage unit 120. The received power map generation unit 130 acquires the wireless information at the large number of initial measurement points stored in the wireless information storage unit 120. The intervals between the initial monitoring points may be equal to each other as illustrated in FIG. 11, or may be different from one another. For example, measurement may be performed at narrow intervals in an area where a change in received power is large, and measurement may be performed at wide intervals in an area where a change in received power is small. In an area close to the transmission source, the measurement may be performed at narrow intervals, and in an area far from the transmission source, the measurement may be performed at wide intervals. In a case where the movement speed of the mobile terminal is slow, the measurement may be performed at narrow intervals, and in a case where the movement speed is fast, the measurement may be performed at wide intervals. In an area frequently used by the application terminal 400, the measurement may be performed at narrow intervals, and in an area less frequently used by the application terminal 400, the measurement may be performed at wide intervals.

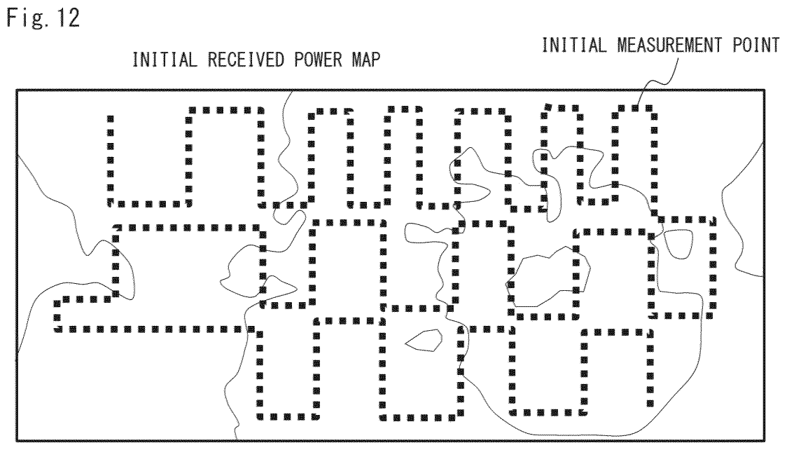

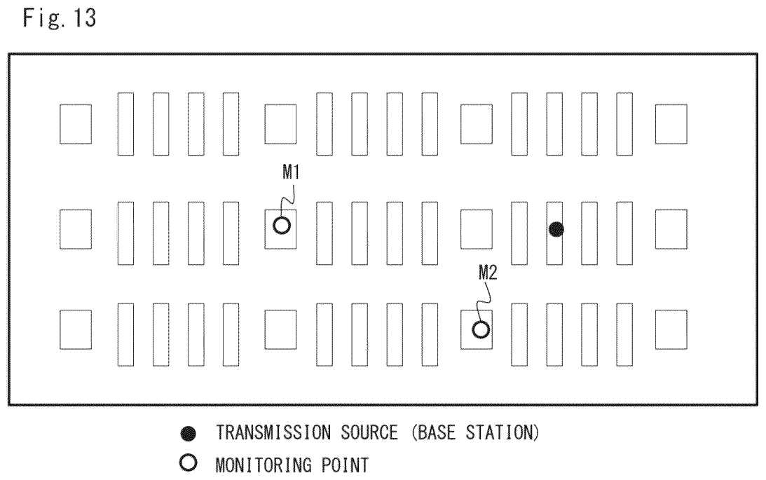

Subsequently, the received power map generation unit 130 generates an initial received power map based on the wireless information acquired from the initial measurement terminal 200 (S122). The received power map generation unit 130 generates an initial received power map indicating a received power distribution before operation based on a plurality of pieces of wireless information including the positional information and the received power information, which are stored in the wireless information storage unit 120. For example, as illustrated in FIG. 12, a received power map indicating a received power distribution on the entire floor is generated from the received power information at a large number of initial measurement points. The received power map generation unit 130 estimates the received power information at each point other than the initial measurement point (the initial measurement point may be included) based on the received power information at the initial measurement point, and generate the received power map of the entire floor. The estimation method may be spatial interpolation such as linear interpolation or kriging, or may be another method. The received power map is data in which the received power is mapped to each position in a target space such as a floor, and can be represented by a heat map or a contour line corresponding to the received power at each position.

Subsequently, the received power map generation unit 130 acquires wireless information from the operational monitoring terminal 300 during the operation (S123). After the initial received power map is generated before operation, during the operation, the operational monitoring terminal 300 measures the received power at the position of a predetermined monitoring point, and transmits the wireless information including the measured received power information to the operational management server 100. For example, as illustrated in FIG. 13, the operational monitoring terminals 300 are disposed at two monitoring points M1 and M2, the received power at the monitoring points M1 and M2 is measured, and the received power map generation unit 130 acquires the received power information at the monitoring points M1 and M2. The positional information of the monitoring point may be acquired from the operational monitoring terminal 300 or may be set in advance. The number of monitoring points (operational monitoring terminals 300) that perform monitoring during operation is, for example, two, but may be any number equal to or greater than one.

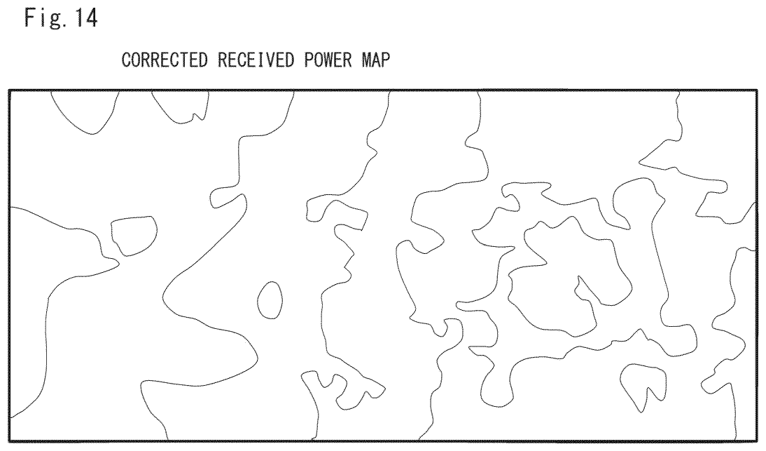

Subsequently, the received power map generation unit 130 corrects the initial received power map based on the wireless information acquired from the operational monitoring terminal 300 (S124). The received power map generation unit 130 corrects the received power information of the entire initial received power map using the received power information of the monitoring point measured by the operational monitoring terminal 300 and the received power information of the entire generated initial received power map. For example, the received power information of the initial received power map of FIG. 12 is corrected using the received power information of the monitoring points M1 and M2 of FIG. 13, and the corrected received power map as illustrated in FIG. 14 is generated. The received power map generation unit 130 outputs the corrected received power map as a received power map for display. During operation, S123 and S124 may be periodically repeated to update the received power map to be displayed as needed.

For example, the received power map generation unit 130 corrects the received power at each point using a power prediction model that predicts the received power at a target point from the received power at two input points. The power prediction model is a model representing a relationship between the received power at two input points and the received power at a target point, and is represented by the following Equation (1).

$$\begin{matrix}[ Math . 1 ] & \\ {y}_{P ( x )} = {w}_{P ( x )} {y}_{p 1} + ( 1 - {w}_{P ( x )} ) {y}_{p 2} & ( 1 )\end{matrix}$$

In Equation (1), yₚ₁ represents the received power at a first input point, yₚ₂ represents the received power at a second input point, yₚ₍ₓ₎ represents the received power at a target point x, and Wₚ₍ₓ₎ represents a weight (relationship parameter) representing the relationship between yₚ₁ and yₚ₂, and yₚ₍ₓ₎ at the target point x.

First, the received power map generation unit 130 acquires the received power at each point from the generated initial received power map, and obtains the weight Wₚ₍ₓ₎ at each point by using Equation (1). If the first input point and the second input point are used as the monitoring points M1 and M2 of the operational monitoring terminal 300, in Equation (1), the weight wₚ₍ₓ₎ at the target point x is obtained by inputting the received power at the monitoring point M1 in the initial received power map to yₚ₁, the received power at the monitoring point M2 in the initial received power map to yₚ₂, and the received power at the target point x in the initial received power map to yₚ₍ₓ₎. Thus, the weight Wₚ₍ₓ₎ at each point of the entire initial received power map is obtained.

Next, the received power map generation unit 130 predicts the received power at each point using Equation (1) based on the received power measured by the operational monitoring terminal 300. In Equation (1), a prediction value yₚ₍ₓ₎ of the received power at the target point x is obtained by inputting the received power at the monitoring points M1 and M2 measured by the operational monitoring terminal 300 to yₚ₁ and yₚ₂, and assigning the obtained weight at the target point x to wₚ₍ₓ₎. Thus, the prediction value yₚ₍ₓ₎ of the received power at each point on the entire initial received power map is obtained, and the received power information of the initial received power map is corrected using the prediction value.

Returning to FIG. 9, subsequently, the operational management server 100 estimates the deterioration factor of the communication quality based on the received power information (S130). In a case where the received power map for display is generated, the deterioration factor estimation unit 140 inputs the received power information at each point on the generated received power map to the deterioration factor estimation model 141, and estimates the deterioration factor of the communication quality at each point. In a case where the received power information is acquired from the application terminal 400, the deterioration factor estimation unit 140 inputs the acquired received power information to the deterioration factor estimation model 141 to estimate the deterioration factor of the communication quality of the application terminal 400.

Subsequently, the operational management server 100 estimates the impact degree on the communication quality for each deterioration factor based on the received power information (S140). In a case where the received power map for display is generated, the impact degree estimation unit 150 estimates the intermediate indicator at each point by inputting the received power information at each point on the generated received power map to the intermediate indicator estimation model 151, and further estimates the deterioration degree of the communication quality at each point by inputting the estimated intermediate indicator at each point to a predetermined transformation function. In a case where the received power information is acquired from the application terminal 400, the impact degree estimation unit 150 estimates the intermediate indicator by inputting the acquired received power information to the intermediate indicator estimation model 151, and further estimates the deterioration degree of the communication quality of the application terminal 400 by inputting the estimated intermediate indicator to a predetermined transformation function.

Subsequently, the operational management server 100 displays an operational management screen (S150). The display unit 160 displays the generated received power map of a predetermined area, the deterioration factor of the communication quality estimated in the predetermined area, and the impact degree on the communication quality for each deterioration factor estimated in the predetermined area on the operational management screen.

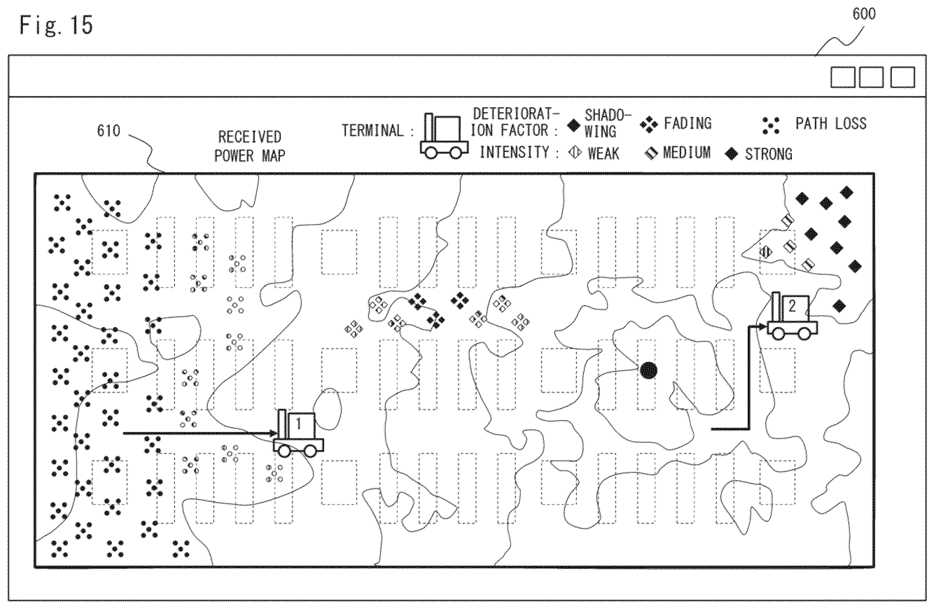

FIG. 15 illustrates an example of the operational management screen displayed by the display unit 160. In the example of FIG. 15, an operational management screen 600 includes a received power map screen 610. As illustrated in FIG. 15, the display unit 160 displays the generated received power map for display on the received power map screen 610 of the operational management screen 600. Thus, the received power distribution on the floor estimated from the received power measured at the monitoring point can be displayed in real time. For example, the floor map may be displayed on the received power map screen 610, and the received power map generated on the floor map may be displayed. The floor map may be a map indicating a position and shape of an object disposed on the floor, or may be an image obtained by imaging the floor. The received power map may be displayed as a heat map corresponding to the received power at each point, or may be displayed by a contour line indicating the received power. In the case of being displayed as the heat map, the color, the hatching pattern, and the like at each point may be changed according to the received power. In the received power map, an area where the received power is lower than a predetermined threshold may be highlighted using the color, the hatching pattern, or the like.

The display unit 160 identifiably displays the deterioration factor of the communication quality estimated at each point on the received power map. Thus, it is possible to simultaneously display the received power distribution on the floor and the deterioration factor of the communication quality in real time. For example, as illustrated in FIG. 15, the deterioration factors such as shadowing, fading, and path loss are displayed using different icons at each point on the received power map. Without being limited to the type and shape of the icon, the color, size, and the like of the icon may be changed for each deterioration factor. Not only the icons but also the characters of “shadowing”, “fading”, and “path loss” as the deterioration factors may be displayed at each point. The deterioration factor may be identifiably displayed for each point on the received power map, or the deterioration factor may be identifiably displayed for each area including a point having the same estimated deterioration factor.

The display unit 160 identifiably displays the deterioration degree (impact degree) on the communication quality estimated at each point on the received power map. Thus, it is possible to simultaneously display the received power distribution on the floor and the deterioration degree of the communication quality in real time. For example, as illustrated in FIG. 15, the color of the icon indicating the deterioration factor may be changed and displayed at each point on the received power map according to levels of deterioration degree: low, medium, and high. Without being limited to the color of the icon, the type, shape, size, and the like of the icon may be changed according to the deterioration degree. As the deterioration degree increases, the icon may be displayed to be highlighted using the color or the like. The method for highlighting is not limited, but for example, icons may be displayed in a blinking manner, icons having different sizes may be alternately displayed, the background color of the icons may be changed, or another icon such as an exclamation mark may be added to the icon indicating the deterioration factor and displayed. The deterioration degree may be displayed using an icon different from the icon indicating the deterioration factor at each point on the received power map. The deterioration degree to be displayed may be a total value of the estimated deterioration degrees of the deterioration factors, or may be a deterioration degree of a deterioration factor having the greatest deterioration degree. The intensity of the deterioration degree is not limited to three levels: weak, medium, and strong, and the display of the icon may be changed according to an arbitrary number of levels. Not only the icons but also the character indicating the level of the estimated deterioration degree or the value of the deterioration degree (deterioration amount or the like) may be displayed at each point. The deterioration degree may be identifiably displayed for each point on the received power map, or the deterioration degree may be identifiably displayed for each area including points having the same level of the estimated deterioration degree.

In a case where the wireless information including the positional information is acquired from the application terminal 400, the display unit 160 identifiably displays the position of the application terminal 400 on the received power map. Thus, it is possible to identify the current position where the application terminal 400 is operating on the map indicating the received power distribution, the deterioration factor, and the deterioration degree. For example, as illustrated in FIG. 15, an icon indicating the application terminal 400 is displayed at a position corresponding to the positional information acquired on the received power map. In a case where a plurality of the application terminals 400 are displayed, the application terminals 400 may be identifiably displayed. For example, the identification number of each terminal may be displayed on the icon of the application terminal 400, or the color and type of the icon may be changed for each application terminal 400.

The icon of the application terminal 400 may display the received power acquired from the terminal, the deterioration factor estimated from the received power, and the deterioration degree. The type, color, size, and the like of the icon may be changed according to the received power, the deterioration factor, and the deterioration degree. Not only the icons, the value of the received power, the character of the deterioration factor, the value of the deterioration degree, and the like may be displayed.

The past movement trajectory (movement route) may be displayed according to the positional information of the application terminal 400 together with the icon of the application terminal 400. The movement trajectory may include a future movement route from information indicating an operation plan or a design. The information indicating the operation plan and the design may be acquired from an operational management database or the like. The movement trajectory may be displayed by a trajectory line indicating the movement trajectory, or the icons of a plurality of terminals may be displayed side by side along the movement trajectory. On the movement trajectory, the received power acquired from the terminal, the deterioration factor estimated from the received power, and the deterioration degree may be displayed.

An operator may be allowed to select an item to be displayed on the received power map screen 610. For example, only information selected from the floor map, the received power map, the deterioration factor, the deterioration degree, and the application terminal may be displayed on the received power map screen 610. For example, only the received power map and deterioration factor may be displayed, or only the received power map and application terminal may be displayed. Only the information of the deterioration factor selected from the plurality of deterioration factors may be displayed, or only the information of the application terminal selected from a plurality of the application terminals may be displayed.

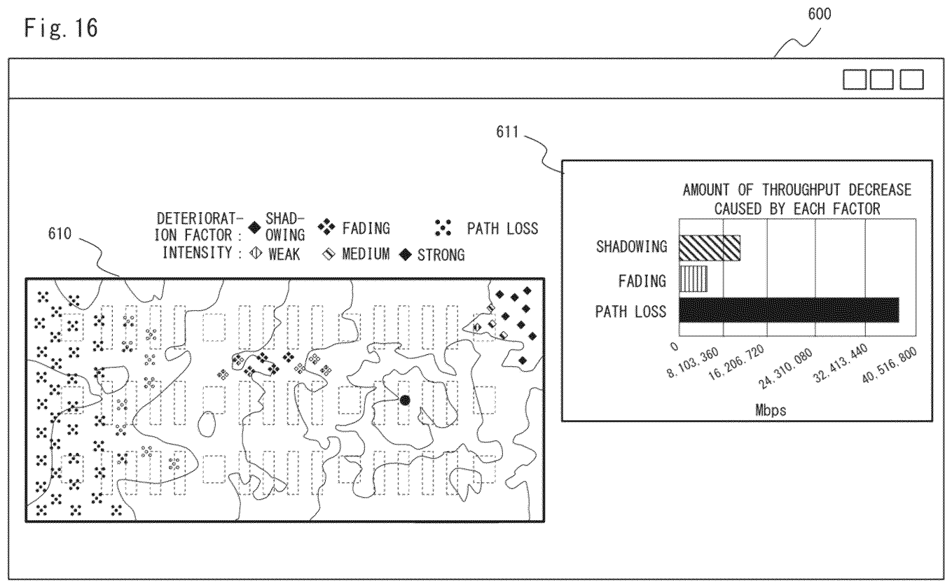

The display unit 160 may display the deterioration degree of the estimated communication quality on a screen different from the received power map screen 610. By using the different screen, more detailed information can be displayed. For example, as illustrated in FIG. 16, the deterioration degree of the communication quality for each deterioration factor may be displayed on a dashboard screen 611 different from the received power map screen 610. For example, in a case where the operator performs a selection operation such as clicking on an icon indicating a deterioration factor displayed on the received power map screen 610, the dashboard screen 611 may be displayed to display the deterioration degree estimated at the position of the selected icon. The position selected by the operator is an arbitrary point on the received power map, and the position may be a position where an icon of a deterioration factor is displayed or a position where an icon of the application terminal 400 is displayed. In order to recognize the relationship between the selection position of the received power map screen 610 and the dashboard screen 611, for example, a line or an arrow connecting the selected position on the received power map screen 610 and the dashboard screen 611 may be displayed, the dashboard screen 611 may be displayed in a pop-up to pop up from the selected position on the received power map screen 610, or information of the selected position on the received power map screen 610 may be displayed on the dashboard screen 611. In the example of FIG. 16, the dashboard screen 611 is displayed on the right side of the received power map screen 610, but without being limited to the right side, and the dashboard screen 611 may be displayed at an arbitrary position (on the left side, upper side, lower side, and the like) around the received power map screen 610. A part or all of the dashboard screen 611 may be displayed to overlap the received power map screen 610. The dashboard screen 611 is an example of a screen that displays detailed information of the deterioration degree, and may be a pop-up having an arbitrary shape or size. For example, as illustrated in FIG. 16, the deterioration degree (for example, the amount of decrease in throughput) of the communication quality for each estimated deterioration factor is displayed as a bar graph on the dashboard screen 611. Not only the bar graph but also other types of graphs may be displayed, or the value of the deterioration degree may be displayed. For example, the deterioration factor having the largest deterioration degree or the deterioration factor greater than a predetermined threshold may be highlighted by changing the color or the hatching pattern of the graph. A line graph or the like may display a temporal change in the deterioration degree of the communication quality for each deterioration factor. The relative relationship among deterioration amounts caused by the deterioration factor may be illustrated by a pie chart.

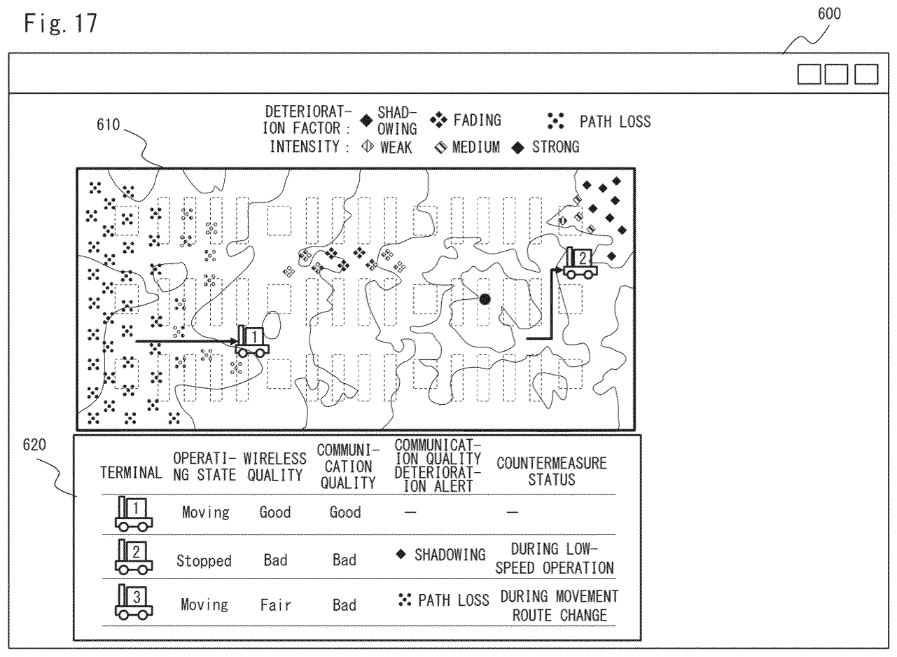

FIG. 17 illustrates another example of the operational management screen displayed by the display unit 160. In the example of FIG. 17, the operational management screen 600 includes a terminal management screen 620 in addition to the received power map screen 610. The display unit 160 displays the state and the like of the application terminal 400 on the terminal management screen 620 of the operational management screen 600. As illustrated in FIG. 17, for example, the operating state, the wireless quality, the communication quality, the communication quality deterioration alert, the countermeasure status, and the like of each terminal are displayed in a list on the terminal management screen 620. Thus, the current state of each application terminal 400 can be identified in real time.

The operating state displayed on the terminal management screen 620 is, for example, a state of being in operation (Moving), a state of being stopped (Stopped), or the like. The display unit 160 may determine whether the application terminal 400 is in operation or is stopped based on the positional information acquired from the application terminal 400 and display a determination result.

The wireless quality displayed on the terminal management screen 620 is, for example, a level of received power, and may be good, fair, or bad. The wireless quality is not limited to three levels of the received power, the received power may be displayed in any number of levels, or the value of the received power may be displayed. The display unit 160 may determine the level of the received power based on the received power information acquired from the application terminal 400 and display the determination result. The level of the received power may be determined based on a value range of each level set in a state where the value range of the received power for each level is set in advance, or may be determined based on a value range of each level selected in a state where the value range of each level is selected according to the type or operation type of the application terminal 400.

The communication quality displayed on the terminal management screen 620 is, for example, a level of throughput, and may be good, fair, or bad. The communication quality is not limited to three levels, the throughput may be displayed in any number of levels, or the value of the throughput may be displayed. The display unit 160 may determine the level of the throughput based on the throughput estimated from the received power information acquired from the application terminal 400 and display the determination result. Similarly to the level of the received power, the level of the throughput may be determined based on a value range of each level set in a state where the value range of the throughput for each level is set in advance, or may be determined based on a value range of each level selected in a state where the value range of each level is selected according to the type or operation type of the application terminal 400.

The communication quality deterioration alert displayed on the terminal management screen 620 is, for example, a deterioration factor and a deterioration degree of the communication quality. Similarly to the display of the received power map screen 610, the display unit 160 may change the icon, the color of the icons, and the like for display according to the deterioration factor and deterioration degree estimated from the received power information acquired from the application terminal 400. The communication quality deterioration alert may be highlighted according to the deterioration factor or the deterioration degree. As the highlighted display, for example, a red character (which may have other color) indicating a deterioration factor or a deterioration degree of the communication quality may be displayed, a red frame (which may have other color) surrounding an icon or a character may be displayed, or an icon or a character may be blinked. On the received power map of the received power map screen 610, in addition to the icon of the application terminal 400, an icon or a red character corresponding to the deterioration factor or a deterioration degree may be displayed, or a red frame surrounding the icon or the character may be displayed. In a case where the deterioration degree is equal to or more than a predetermined value, a pop-up indicating an alert may be displayed separately from the terminal management screen 620, or a sound indicating the alert may be output without being limited to the screen display.

The countermeasure status displayed on the terminal management screen 620 is, for example, the current state of a terminal with bad communication quality. For example, the display unit 160 may acquire positional information or information indicating the current state from the application terminal 400 and display a state during low-speed operation or during a movement route change.

The operator may select whether to display the terminal management screen 620 on the operational management screen 600. In a case where the terminal management screen 620 is displayed, an operator may be allowed to select an item to be displayed on the terminal management screen 620. For example, only information selected from the operating state, the wireless quality, the communication quality, the communication quality deterioration alert, and the countermeasure status may be displayed on the terminal management screen 620. For example, only the operating state and communication quality may be displayed, or only the operating state and communication quality deterioration alert may be displayed. Only the information regarding an application terminal selected among a plurality of the application terminals may be displayed.

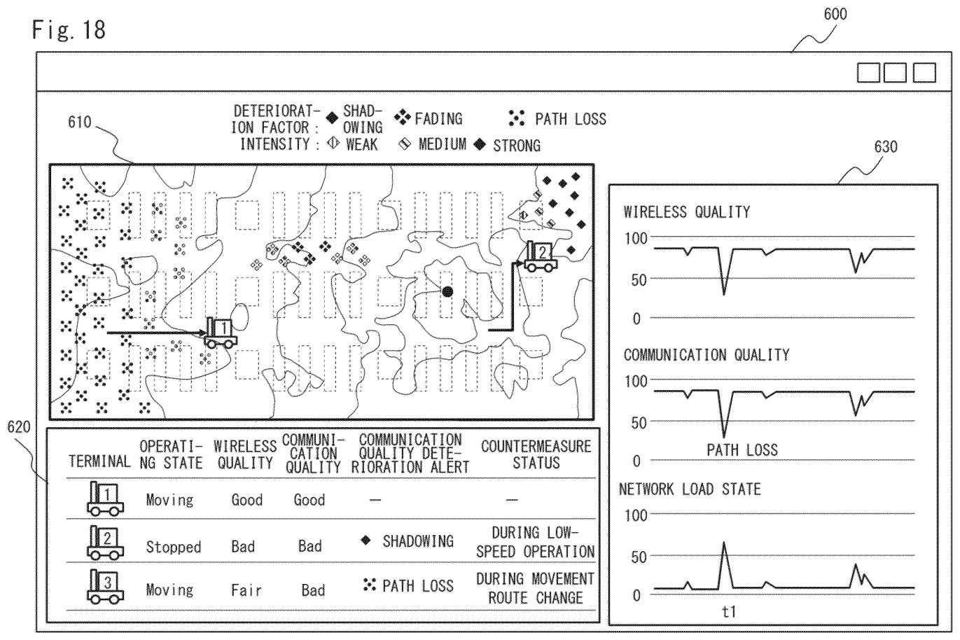

FIG. 18 illustrates still another example of the operational management screen displayed by the display unit 160. In the example of FIG. 18, the operational management screen 600 includes a graph screen 630 in addition to the received power map screen 610 and the terminal management screen 620. The display unit 160 displays a temporal change in the state of the application terminal 400 or the state of the network on the graph screen 630. As illustrated in FIG. 18, for example, the wireless quality, the communication quality, network load information, and the like are displayed on the graph screen 630. Thus, it is possible to identify a temporal change in quality of the entire network and resources in the target wireless communication environment. FIG. 18 merely illustrates an example of a display image of each graph, and does not intend to specify a value, a unit, or the like on each axis.

The wireless quality displayed on the graph screen 630 is, for example, received power of the application terminal 400. The vertical axis of the graph representing the wireless quality relatively indicates the strength of the received power in 100 stages. The display unit 160 may plot the received power information acquired from the application terminal 400 in time series and display a change in the received power using a line graph. Not only the line graph but also other types of graphs may be displayed, or the value of the received power may be displayed in time series. The received power of one application terminal 400 may be displayed, or the received power of a plurality of the application terminals 400 may be displayed in an overlapping manner.

The communication quality displayed on the graph screen 630 is, for example, throughput of the application terminal 400. The vertical axis of the graph representing the communication quality indicates throughput (for example, Mbps). The display unit 160 may plot the throughput estimated from the received power information acquired from the application terminal 400 in time series and display a change in the throughput using a line graph. Not only the line graph but also other types of graphs may be displayed, or the value of the throughput may be displayed in time series. The throughput of one application terminal 400 may be displayed, or the throughput of a plurality of the application terminals 400 may be displayed in an overlapping manner.

The network load state displayed on the graph screen 630 is, for example, a utilization rate of radio resources in the entire network. The vertical axis of the graph representing the network load state indicates the utilization rate (for example, percentage) of the radio resource. For example, the display unit 160 may acquire and display the resource allocation state from the base station in the target wireless communication environment. In the example of the graph screen 630 of FIG. 18, at time t1, the wireless quality decreases, and at the same time, the communication quality also decreases, and the network load increases. For example, at time t1, it can be known that the wireless quality environment is poor in a case where the communication quality is not improved even when the allocation of the radio resources is increased.

The operator may select whether to display the graph screen 630 on the operational management screen 600. In a case where the graph screen 630 is displayed, the operator may be allowed to select an item to be displayed on the graph screen 630. For example, only information selected from the wireless quality, the communication quality, and the network load state may be displayed on the graph screen 630. For example, only the wireless quality and communication quality may be displayed, or only the network load state may be displayed. Only the wireless quality or communication quality of the application terminal selected among a plurality of the application terminals may be displayed. A period to be displayed in the graph representing the wireless quality, the communication quality, and the network load state may be selected.

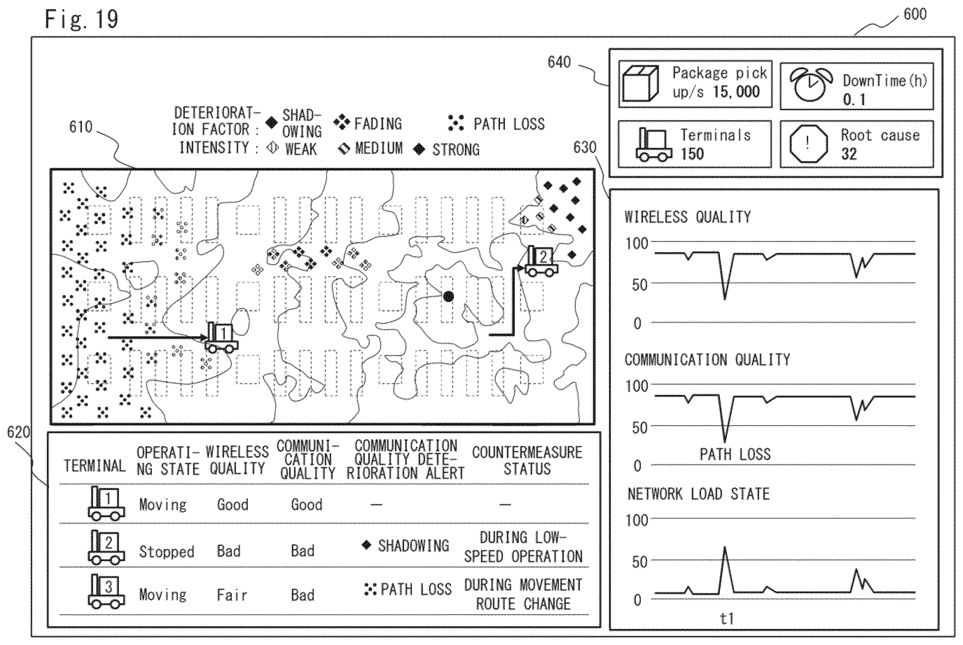

FIG. 19 illustrates still another example of the operational management screen displayed by the display unit 160. In the example of FIG. 19, the operational management screen 600 includes an application management screen 640 in addition to the received power map screen 610, the terminal management screen 620, and the graph screen 630. The display unit 160 displays the operating state and the like of the application terminal 400 on the application management screen 640. As illustrated in FIG. 19, for example, a package transport speed (Package pick up/s), a down time (Down Time), a terminal (Terminals), a root cause (Root cause), and the like are displayed on the application management screen 640. Thus, the operational state of the entire system provided by the application terminal 400 can be identified.

For example, in a case where the application terminal 400 is an AGV that transports a package, Package pick up/s displayed on the application management screen 640 is the package transport speed of all the application terminals 400. The display unit 160 may acquire information indicating the transport state of the package from all the application terminals 400, obtain the transport speed from the acquired transport state, and display the transport speed.

Down time displayed on the application management screen 640 is, for example, a time during which the application terminal 400 is stopped due to deterioration in wireless quality or the like. The ratio of the stopped application terminals and the number of the stopped application terminals may be displayed. The display unit 160 may acquire information indicating an operating state from all the application terminals 400, and obtain a time during a stop from the acquired operating state for display.

Terminals displayed on the application management screen 640 is, for example, the number of application terminals 400 accommodated in the system. Root cause displayed on the application management screen 640 is, for example, the number of failures occurring in the application terminal 400. For example, the number of terminals with bad wireless quality or bad communication quality may be displayed based on the received power information acquired from all the application terminals 400.

The operator may select whether to display the application management screen 640 on the operational management screen 600. In a case where the application management screen 640 is displayed, the operator may be allowed to select an item to be displayed on the application management screen 640. For example, only information selected from Package pick up/s, Down time, Terminals, and Root cause may be displayed on the application management screen 640. For example, only Package pick up/s and Terminals may be displayed, or only Down time and Root cause may be displayed.

As described above, in the present example embodiment, the received power map indicating the received power distribution is displayed on the operational management screen, and the deterioration factor of the communication quality estimated from the received power and the impact degree on the communication quality for each deterioration factor are superimposed and displayed on the received power map. Thus, it is possible to identify at a glance the deterioration factor of the communication quality at each point and the impact degree on the communication quality for each deterioration factor together with the received power at each point. For example, the operator can consider necessity of countermeasures and a countermeasure policy from the received power at each point identified from the map and the deterioration factor of the communication quality, and can further consider a countermeasures in more detail based on the impact degree on the communication quality for each deterioration factor.

By displaying the deterioration factor at each point on the received power map, it is possible to identify which deterioration factor deteriorates the communication quality at each point, whether the communication quality deteriorates due to a plurality of deterioration factors, what kind of deterioration factors exist in the surrounding points, and the like, and thus, it is possible to specifically consider countermeasures for each point where the communication quality deteriorates. By displaying the impact degree on the communication quality for each deterioration factor, it is possible to identify which deterioration factor has the greatest impact, and thus it is possible to implement more effective countermeasures. By displaying the received power map screen, the terminal management screen, and the like on the operational management screen, it is possible to further provide information necessary for considering countermeasures, and by selecting information required by the operator, it is possible to effectively provide information suitable for each site.

### Second Example Embodiment

Next, a second example embodiment will be described. In the present example embodiment, an example of superimposing and displaying the deterioration factor of the communication quality on a throughput map will be described. The present example embodiment can be implemented in combination with the first example embodiment, and each component described in the first example embodiment may be appropriately used.

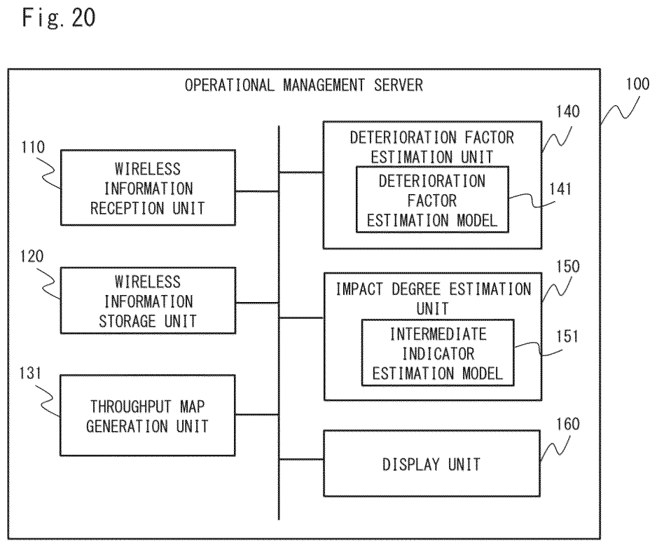

FIG. 20 illustrates a configuration example of the operational management server 100 according to the present example embodiment. As illustrated in FIG. 20, the operational management server 100 according to the present example embodiment includes a throughput map generation unit 131 instead of the received power map generation unit 130 of the first example embodiment. Other configurations are similar to those in the first example embodiment.

The throughput map generation unit 131 generates a throughput map indicating a throughput distribution in a predetermined area based on the wireless information received from each terminal by the wireless information reception unit 110 and stored in the wireless information storage unit 120. Not only the throughput map but also the communication quality map indicating a delay or another communication quality distribution may be generated. For example, the throughput map generation unit 131 may estimate the throughput from the received power information included in the wireless information and generate the throughput map based on the estimated throughput, or may measure the throughput in each terminal and acquire the measured throughput from each terminal to generate the throughput map. The method for generating a throughput map is similar to the method for generating a received power map of the first example embodiment. For example, the throughput map generation unit 131 may generate the throughput map based on the wireless information acquired from any one of the initial measurement terminal 200, the operational monitoring terminal 300, and the application terminal 400, or may generate the throughput map based on the wireless information acquired from each terminal.

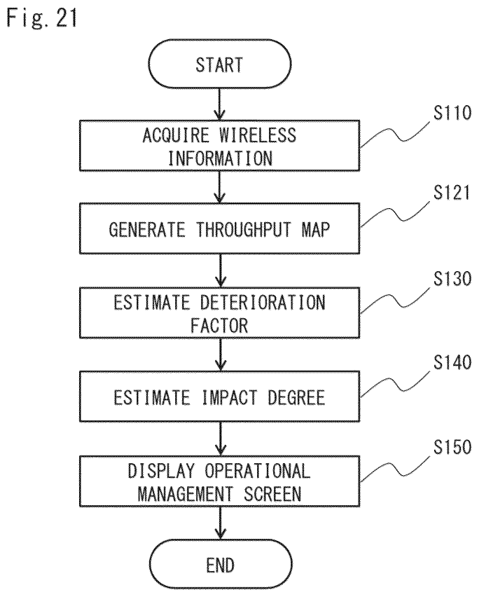

FIG. 21 illustrates an operational example of the operational management server 100 according to the present example embodiment. As illustrated in FIG. 21, the operational management server 100 acquires the wireless information from each terminal as in the first example embodiment (S110). Each terminal may measure the received power and transmit the wireless information including the measured received power information and the positional information to the operational management server 100. Each terminal may measure the received power and the throughput, and transmit the wireless information including the measured received power information, the throughput information, and the positional information to the operational management server 100. The wireless information reception unit 110 acquires, from each terminal, the wireless information including the received power information and the positional information or the wireless information including the received power information, the throughput information, and the positional information.

Subsequently, the operational management server 100 generates a throughput map from the acquired wireless information (S121). Similarly to FIG. 10 of the first example embodiment, the throughput map generation unit 131 acquires the wireless information from the initial measurement terminal 200 before operation, and generates an initial throughput map based on the wireless information acquired from the initial measurement terminal 200. The throughput map generation unit 131 generates the initial throughput map based on the throughput information estimated from the received power information included in the wireless information or the throughput information included in the wireless information. The throughput map generation unit 131 acquires the wireless information from the operational monitoring terminal 300 during operation, and corrects the initial throughput map based on the wireless information acquired from the operational monitoring terminal 300. As in the first example embodiment, the throughput map generation unit 131 corrects the throughput information of the initial throughput map based on the throughput information at two monitoring points using Equation (1).

Subsequently, as in the first example embodiment, the operational management server 100 estimates the deterioration factor of the communication quality based on the received power information included in the wireless information (S130), and estimates the impact degree on the communication quality for each deterioration factor based on the received power information included in the wireless information (S140).

Subsequently, the operational management server 100 displays an operational management screen (S150). The display unit 160 displays the generated throughput map of a predetermined area, the deterioration factor of the communication quality estimated in the predetermined area, and the impact degree on the communication quality for each deterioration factor estimated in the predetermined area on the operational management screen.

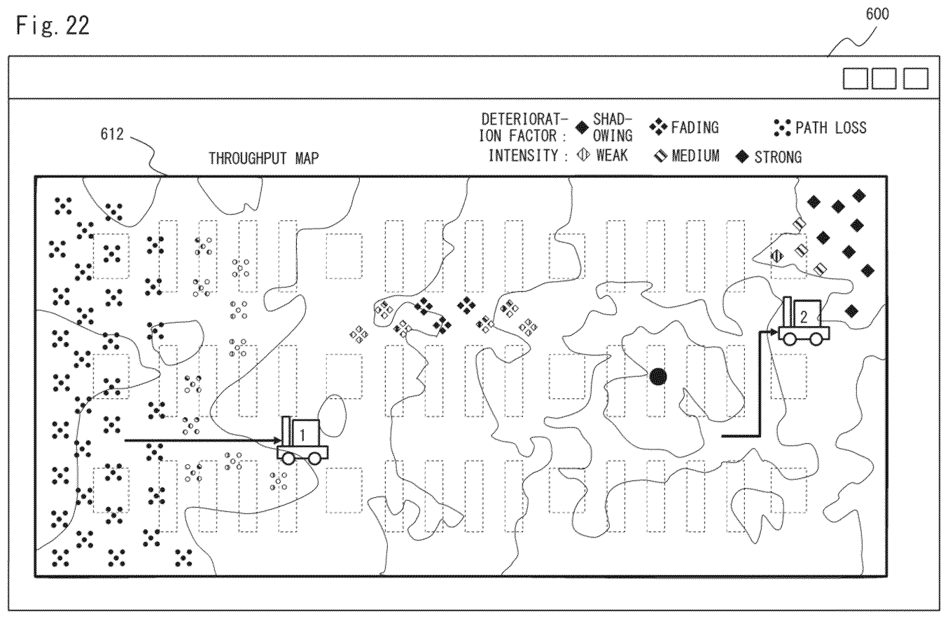

FIG. 22 illustrates a display example of the operational management screen according to the present example embodiment. In the example of FIG. 22, the operational management screen 600 includes a throughput map screen 612. As in the first example embodiment, the operational management screen 600 may include the terminal management screen 620, the graph screen 630, and the application management screen 640 in addition to the throughput map screen 612.

As illustrated in FIG. 22, the display unit 160 displays the generated throughput map on the throughput map screen 612 of the operational management screen 600. As in the first example embodiment, for example, a floor map may be displayed on the throughput map screen 612, and the generated throughput map may be displayed on the floor map. The throughput map may be displayed as a heat map corresponding to the throughput at each point, or may be displayed by a contour line indicating the throughput. The operator may select whether to display the throughput map screen 612 of the present example embodiment or whether to display the received power map screen 610 of the first example embodiment on the operational management screen 600.

As in the first example embodiment, the display unit 160 identifiably displays the deterioration factor of the communication quality estimated at each point on the throughput map, and identifiably displays the deterioration degree (impact degree) on the communication quality estimated at each point on the throughput map. A method for displaying a deterioration factor of communication quality and a method for displaying a deterioration degree of communication quality are similar to those in the first example embodiment. A method for displaying an application terminal 400 and the like is also similar to that of the first example embodiment.

As described above, in the present example embodiment, the throughput map indicating a throughput distribution is displayed on the operational management screen, and the deterioration factor of the communication quality estimated from the received power and the impact degree on the communication quality for each deterioration factor are superimposed and displayed on the throughput map. Thus, as in the first example embodiment, it is possible to identify at a glance the deterioration factor of the communication quality at each point and the impact degree on the communication quality for each deterioration factor together with the throughput at each point.

The present disclosure is not limited to the above-described example embodiments, and can be appropriately modified without departing from the scope. For example, the received power map may be generated based on not only the received power measured by the terminal but also the received power obtained by simulation or the like and both the received power measured by the terminal and the received power obtained by simulation or the like. The throughput and the delay may also include simulation and estimation.

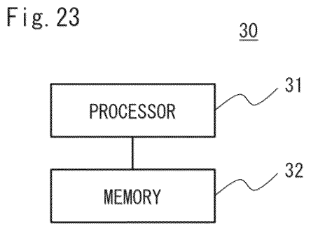

Each configuration in the above-described example embodiments may be implemented by hardware, software, or both, and may be implemented by one piece of hardware or software or by a plurality of pieces of hardware or software. The devices and functions (processing) including the operational management server and the terminal may be implemented by a computer 30 including a processor 31 such as a central processing unit (CPU), and a memory 32 which is a storage device, as illustrated in FIG. 23. For example, a program for performing the method (display method) in the example embodiment may be stored in the memory 32, and each function may be achieved by the processor 31 executing the program stored in the memory 32.

These programs include a group of instructions (or software code) causing a computer to perform one or more functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, and a magnetic cassette, a magnetic tape, a magnetic disk storage, or other magnetic storage devices. The program may be transmitted through a transitory computer-readable medium or a communication medium. As an example and not by way of limitation, the transitory computer-readable medium or the communication medium includes electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as the following supplementary notes, but are not limited to the following supplementary notes.

### (Supplementary Note 1)

A display system including:
a generation means for generating a wireless communication quality map indicating a wireless communication quality distribution in a target space based on wireless communication quality information regarding wireless communication quality in the target space;
an estimation means for estimating a deterioration factor of communication quality in the target space based on the wireless communication quality information; and a display means for generating display information for superimposing and displaying the estimated deterioration factor of the communication quality on the generated wireless communication quality map.

### (Supplementary Note 2)

The display system according to Supplementary note 1, in which
the estimation means estimates a deterioration degree of the communication quality for each deterioration factor in the target space based on the wireless communication quality information, and
the display means generates the display information for further displaying the estimated deterioration degree.

### (Supplementary Note 3)

The display system according to Supplementary note 2, in which the display means generates the display information for displaying the estimated deterioration degree in association with the wireless communication quality map.

### (Supplementary Note 4)

The display system according to any one of Supplementary notes 1 to 3, in which
the wireless communication quality information includes wireless quality information indicating wireless quality,
the generation means generates a wireless quality map indicating a wireless quality distribution based on the wireless quality information, and
the display means generates the display information for displaying the generated wireless quality map.

### (Supplementary Note 5)

The display system according to any one of Supplementary notes 1 to 3, in which
the wireless communication quality information includes communication quality information indicating communication quality,
the generation means generates a communication quality map indicating a communication quality distribution based on the communication quality information, and
the display means generates the display information for displaying the generated communication quality map.

### (Supplementary Note 6)

The display system according to any one of Supplementary notes 1 to 5, in which the generation means generates a first wireless communication quality map based on the wireless communication quality information measured at a plurality of points in the target space, and corrects the first wireless communication quality map based on the wireless communication quality information of the target space estimated from the wireless communication quality information measured at at least two points in the target space.

### (Supplementary Note 7)

A display device including:
a generation means for generating a wireless communication quality map indicating a wireless communication quality distribution in a target space based on wireless communication quality information regarding wireless communication quality in the target space;
an estimation means for estimating a deterioration factor of communication quality in the target space based on the wireless communication quality information; and
a display means for generating display information for superimposing and displaying the estimated deterioration factor of the communication quality on the generated wireless communication quality map.

### (Supplementary Note 8)

The display device according to Supplementary note 7, in which
the estimation means estimates a deterioration degree of the communication quality for each deterioration factor in the target space based on the wireless communication quality information, and
the display means generates the display information for further displaying the estimated deterioration degree.

### (Supplementary Note 9)

The display device according to Supplementary note 8, in which the display means generates the display information for displaying the estimated deterioration degree in association with the wireless communication quality map.

### (Supplementary Note 10)

The display device according to any one of Supplementary notes 7 to 9, in which
the wireless communication quality information includes wireless quality information indicating wireless quality,
the generation means generates a wireless quality map indicating a wireless quality distribution based on the wireless quality information, and
the display means generates the display information for displaying the generated wireless quality map.

### (Supplementary Note 11)

The display device according to any one of Supplementary notes 7 to 9, in which
the wireless communication quality information includes communication quality information indicating communication quality,
the generation means generates a communication quality map indicating a communication quality distribution based on the communication quality information, and
the display means generates the display information for displaying the generated communication quality map.

### (Supplementary Note 12)

The display device according to any one of Supplementary notes 7 to 11, in which the generation means generates a first wireless communication quality map based on the wireless communication quality information measured at a plurality of points in the target space, and corrects the first wireless communication quality map based on the wireless communication quality information of the target space estimated from the wireless communication quality information measured at at least two points in the target space.

### (Supplementary Note 13)

A display method including:
generating a wireless communication quality map indicating a wireless communication quality distribution in a target space based on wireless communication quality information regarding wireless communication quality in the target space;
estimating a deterioration factor of communication quality in the target space based on the wireless communication quality information; and
generating display information for superimposing and displaying the estimated deterioration factor of the communication quality on the generated wireless communication quality map.

### (Supplementary Note 14)

The display method according to Supplementary note 13, further including:
estimating a deterioration degree of the communication quality for each deterioration factor in the target space based on the wireless communication quality information; and
generating the display information for further displaying the estimated deterioration degree.

### (Supplementary Note 15)

The display method according to Supplementary note 14, further including generating the display information for displaying the estimated deterioration degree in association with the wireless communication quality map.

### (Supplementary Note 16)

The display method according to any one of Supplementary notes 13 to 15, in which
the wireless communication quality information includes wireless quality information indicating wireless quality, and
the method further includes generating a wireless quality map indicating a wireless quality distribution based on the wireless quality information, and generating the display information for displaying the generated wireless quality map.

### (Supplementary Note 17)

The display method according to any one of Supplementary notes 13 to 15, in which
the wireless communication quality information includes communication quality information indicating communication quality, and
the method further includes generating a communication quality map indicating a communication quality distribution based on the communication quality information, and generating the display information for displaying the generated communication quality map.

### (Supplementary Note 18)

The display method according to any one of Supplementary notes 13 to 17, further including:
generating a first wireless communication quality map based on the wireless communication quality information measured at a plurality of points in the target space; and
correcting the first wireless communication quality map based on the wireless communication quality information of the target space estimated from the wireless communication quality information measured at at least two points in the target space.

### REFERENCE SIGNS LIST

1 operational management system
10 display system
11 generation unit
12 estimation unit
13 display unit
20 display device
30 computer
31 processor
32 memory
100 operational management server
110 wireless information reception unit
120 wireless information storage unit
130 received power map generation unit
131 throughput map generation unit
140 deterioration factor estimation unit
141 deterioration factor estimation model
150 impact degree estimation unit
151 intermediate indicator estimation model
160 display unit
200 initial measurement terminal
210 wireless information transmission function
211 received power measurement unit
212 position detection unit
213 wireless information transmission unit
300 operational monitoring terminal
400 application terminal
500 base station
600 operational management screen
610 received power map screen
611 dashboard screen
612 throughput map screen
620 terminal management screen
630 graph screen
640 application management screen

What is claimed is:

1. A display system comprising:
a memory configured to store instructions, and
a processor configured to execute the instructions to;
generate a wireless communication quality map indicating a wireless communication quality distribution in a target space based on wireless communication quality information regarding wireless communication quality in the target space;
estimate a deterioration factor of communication quality in the target space based on the wireless communication quality information; and
generate display information for superimposing and displaying the estimated deterioration factor of the communication quality on the generated wireless communication quality map.

2. The display system according to claim 1, wherein
the processor is further configured to execute the instructions to estimate a deterioration degree of the communication quality for each deterioration factor in the target space based on the wireless communication quality information, and
generate the display information for further displaying the estimated deterioration degree.

3. The display system according to claim 2, wherein the processor is further configured to execute the instructions to generate the display information for displaying the estimated deterioration degree in association with the wireless communication quality map.

4. The display system according to claim 1, wherein
the wireless communication quality information includes wireless quality information indicating wireless quality,
the processor is further configured to execute the instructions to generate a wireless quality map indicating a wireless quality distribution based on the wireless quality information, and
generate the display information for displaying the generated wireless quality map.

5. The display system according to claim 1, wherein
the wireless communication quality information includes communication quality information indicating communication quality,
the processor is further configured to execute the instructions to generate a communication quality map indicating a communication quality distribution based on the communication quality information, and
generate the display information for displaying the generated communication quality map.

6. The display system according to claim 1, wherein the processor is further configured to execute the instructions to generate a first wireless communication quality map based on the wireless communication quality information measured at a plurality of points in the target space, and correct the first wireless communication quality map based on the wireless communication quality information of the target space estimated from the wireless communication quality information measured at at least two points in the target space.

7. A display device comprising:
a memory configured to store instructions, and
a processor configured to execute the instructions to;
generate a wireless communication quality map indicating a wireless communication quality distribution in a target space based on wireless communication quality information regarding wireless communication quality in the target space;
estimate a deterioration factor of communication quality in the target space based on the wireless communication quality information; and
generate display information for superimposing and displaying the estimated deterioration factor of the communication quality on the generated wireless communication quality map.

8. The display device according to claim 7, wherein
the processor is further configured to execute the instructions to estimate a deterioration degree of the communication quality for each deterioration factor in the target space based on the wireless communication quality information, and
generate the display information for further displaying the estimated deterioration degree.

9. The display device according to claim 8, wherein the processor is further configured to execute the instructions to generate the display information for displaying the estimated deterioration degree in association with the wireless communication quality map.

10. The display device according to claim 7, wherein
the wireless communication quality information includes wireless quality information indicating wireless quality,
the processor is further configured to execute the instructions to generate a wireless quality map indicating a wireless quality distribution based on the wireless quality information, and
generate the display information for displaying the generated wireless quality map.

11. The display device according to claim 7, wherein
the wireless communication quality information includes communication quality information indicating communication quality,
the processor is further configured to execute the instructions to generate a communication quality map indicating a communication quality distribution based on the communication quality information, and
generate the display information for displaying the generated communication quality map.

12. The display device according to claim 7, wherein the processor is further configured to execute the instructions to generate a first wireless communication quality map based on the wireless communication quality information measured at a plurality of points in the target space, and correct the first wireless communication quality map based on the wireless communication quality information of the target space estimated from the wireless communication quality information measured at at least two points in the target space.

13. A display method comprising:
generating a wireless communication quality map indicating a wireless communication quality distribution in a target space based on wireless communication quality information regarding wireless communication quality in the target space;
estimating a deterioration factor of communication quality in the target space based on the wireless communication quality information; and
generating display information for superimposing and displaying the estimated deterioration factor of the communication quality on the generated wireless communication quality map.

14. The display method according to claim 13, further comprising:
estimating a deterioration degree of the communication quality for each deterioration factor in the target space based on the wireless communication quality information; and
generating the display information for further displaying the estimated deterioration degree.

15. The display method according to claim 14, further comprising generating the display information for displaying the estimated deterioration degree in association with the wireless communication quality map.

16. The display method according to claim 13, wherein
the wireless communication quality information includes wireless quality information indicating wireless quality, and
the method further comprises generating a wireless quality map indicating a wireless quality distribution based on the wireless quality information, and generating the display information for displaying the generated wireless quality map.

17. The display method according to claim 13, wherein
the wireless communication quality information includes communication quality information indicating communication quality, and
the method further comprises generating a communication quality map indicating a communication quality distribution based on the communication quality information, and generating the display information for displaying the generated communication quality map.

18. The display method according to claim 13, further comprising:
generating a first wireless communication quality map based on the wireless communication quality information measured at a plurality of points in the target space; and
correcting the first wireless communication quality map based on the wireless communication quality information of the target space estimated from the wireless communication quality information measured at at least two points in the target space.
